(19) United States
(12) Patent Application Publication
(10) Pub. No.: US 2009/0069058 A1
(43) Pub. Date: Mar. 12, 2009

(54) SLIDING MECHANISM FOR PORTABLE APPLIANCES

(76) Inventor: Henning Taschke, Bochum (DE)

Correspondence Address: K.F. ROSS P.C., 5683 RIVERDALE AVENUE, SUITE 203 BOX 900, BRONX, NY, 10471-0900, US

(21) Appl. No.: 12/088,035

(22) PCT Filed: Apr. 24, 2007
(86) PCT No.: PCT/DE2007/000729

§ 371 Date: Mar. 25, 2008

(30) Foreign Application Priority Data
May 26, 2006 (DE) 10 2006 025 018.4

(51) Int. Cl. H04M 1/02

(52) U.S. Cl. 455/575.4

(57) ABSTRACT

The invention relates to a sliding mechanism for portable appliances, comprising a first appliance part, for example a lower shell, and a second appliance part, for example an upper shell, the lower shell and upper shell being mutually movably arranged such that they can occupy a first and a second end position in relation to each other under the guidance of a control mechanism defining the direction of movement. At least one spring element is also provided, said spring element having a first articulation point associated with the lower shell and a second articulation point associated with the upper shell, optionally by means of intermediate components. The relative movement of an appliance part from an end position to a force reversal point creates a spring tension of the spring element which drives the appliance part into the other end position thereof. The aim of the invention is to create a novel sliding mechanism for portable appliances with a compact structure. To this end, the inventive sliding mechanism according to claim 1 is provided with a spring element comprising two limbs, each having an articulation point and being interconnected by means of a force deflecting limb which is essentially tension-free even under elastic tension.

The invention relates to a slide mechanism for portable devices, such as cellular telephones, portable computers, or personal digital assistants (PDA's), comprising a first device part, for example a bottom shell, and a second device part, for example a top shell, the bottom shell and top shell being movable relative to each other such that by means of a control mechanism defining the direction of motion they can assume a first end position and second end position, and comprising at least one spring whose one end is connected with the bottom shell and whose other end is connected with the top shell, optionally by means of intermediate parts, the relative spring motion of a device part from one end position to a force reversal point being used to create a spring tension of the spring that pushes the device part to its other end position.

A slide mechanism of this type is known, for example, from EP 1 422 911 [U.S. Pat. No. 6,822,287]. Disclosed therein is a cellular telephone with a top shell and a bottom shell that are disposed in movable fashion relative to each other. The leg springs employed here with a multiply wound center coil force the top shell from its first position to its second position after overcoming a toggle point.

A first publication of prior art that is not verifiable discloses a slide mechanism that employs leg springs with a spiral-type coil.

A publication of verifiable prior art reveals that the slide mechanism therein requires multiple guide elements, thereby resulting in a relatively large overall height. The overall height is furthermore affected by the number of stacked turns of the leg springs, that is the spring height. To sum up, what is disadvantageous about the prior art is the relatively large overall height that conflicts with the miniaturization requirements for portable devices of at the same time ever-increasing functionality.

Even when leg springs with spiral-type coils are used, an overall height of at least two spring turns is required since the inner end of the spiral must run over the other turns to an anchor point on the lower or top shell in order to ensure an appropriate force transmission of the spring energy to the corresponding device part.

The problem to be solved by the invention is therefore to create a novel slide mechanism for portable devices that has a smaller overall height.

This problem is solved by a slide mechanism as described in claim 1, in particular, having the characterizing features that the spring has two spring legs with one connection point each, the spring legs being coupled to each other by a force deflection leg that is essentially tension-free even under spring tension.

In the slide mechanism according to the invention, no stacked spring turns are required, which reduces its overall height accordingly. In addition, the spring according to the invention is able to directly engage the top and bottom shells, without any mediating intermediate parts being required, although such parts can nevertheless by utilized if this is advantageous. Since unlike leg springs having helical-type or spiral-type coils, the spring according to the invention does not require any overlapping spring turns or spring legs and this spring can be fabricated in an especially simple manner, for example, by stamping, and installed in the slide mechanism in an automated production process.

The spring of the slide mechanism is preferably point-symmetric relative to its center point, the center point of the spring being situated approximately at the center of the toggle leg.

The toggle leg causes the spring to effect a rotational motion about its center point as spring tension is created and released.

In an especially advantageous embodiment of the slide mechanism according to the invention, the spring legs are designed as being essentially curved about the toggle leg and/or the center point of the spring, thereby minimizing the movement space for the spring when it effects the rotational motion.

What is furthermore preferred is a slide mechanism, the spring legs of which are of a meander-type design, individual spring-leg segments being associated with each other by means of meander-type bights. It is advantageous in this regard if the spring-leg segments are designed as being essentially curved about the toggle leg and/or the center point of the spring.

The meander-type concatenation of multiple spring-leg segments allows the spring properties in terms of the number, geometry, and length of the individual spring-leg segments to be adapted to the available space, to the force requirements for moving the top and bottom shells together, to the requisite spring travel, as well as to the physical limits of the material employed.

As was already mentioned, curved spring-leg segments result in a smaller space requirement in terms of rotational motion, and due to the contraction of the spring and creation of spring tension allow for greater spring travel.

Depending on the requirements for the slide mechanism, it may be advantageous if the toggle leg has a bearing at the symmetry point at which the spring is rotatably mounted on at least one of the device parts. This prevents the spring from being displaced in addition to its rotational motion by the motion of the device parts relative to each other.

Further advantages of the invention are revealed in the following description of the drawing. Therein:

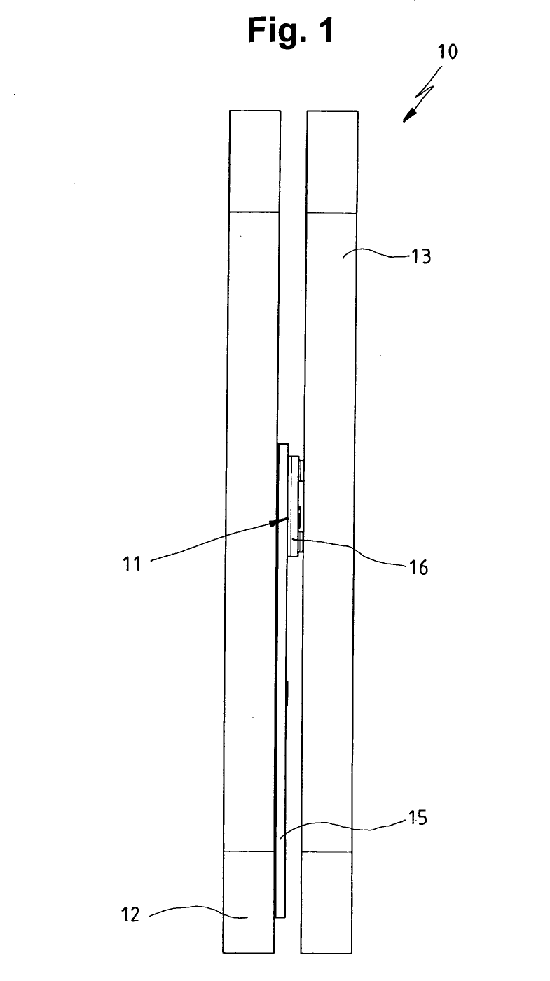

FIG. 1 is a schematic diagram of a device having a slide mechanism according to the invention;

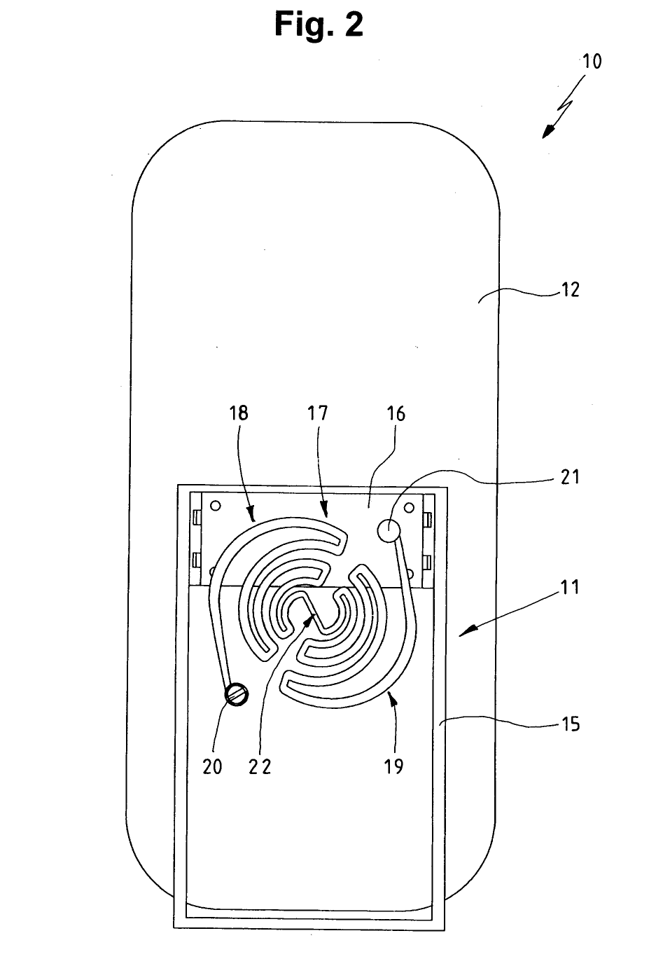

FIG. 2 shows the device of FIG. 1 providing a view of the slide mechanism in its first end position;

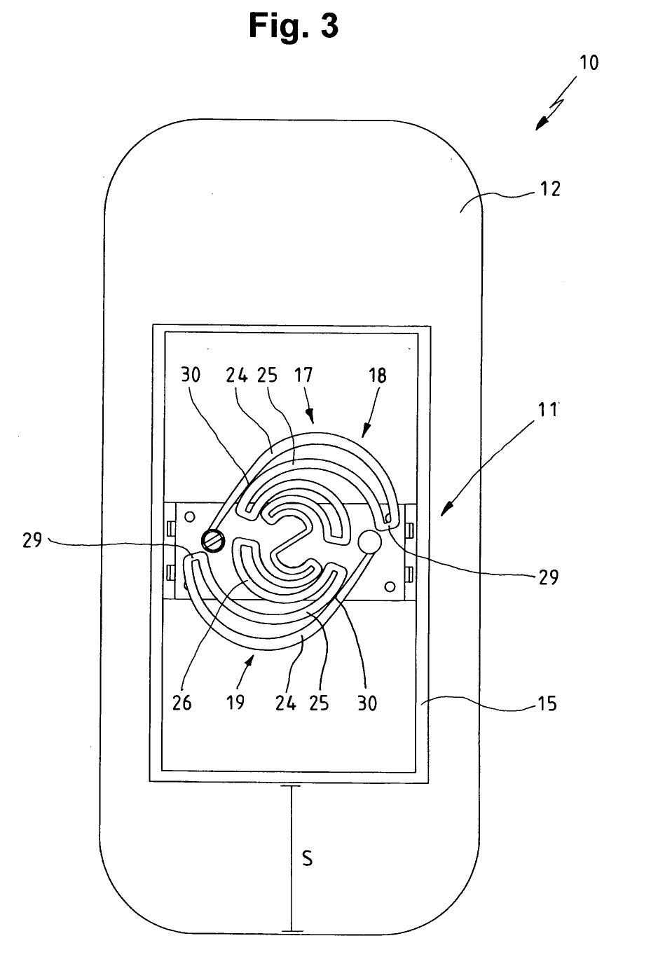

FIG. 3 is a view like FIG. 2 with the device part displaced up to the toggle point;

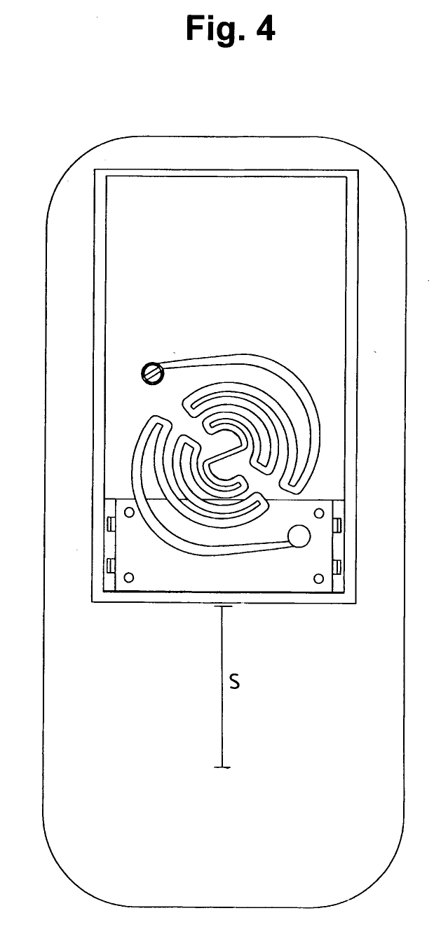

FIG. 4 is a view based on FIG. 2 of the device part displaced to its second end position;

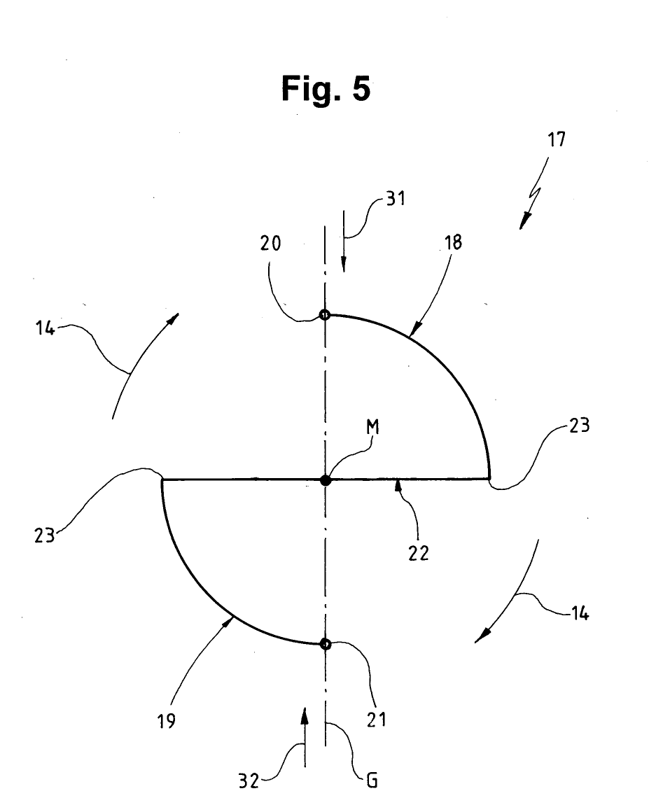

FIG. 5 is a schematic diagram of a base form of a spring usable within the slide mechanism;

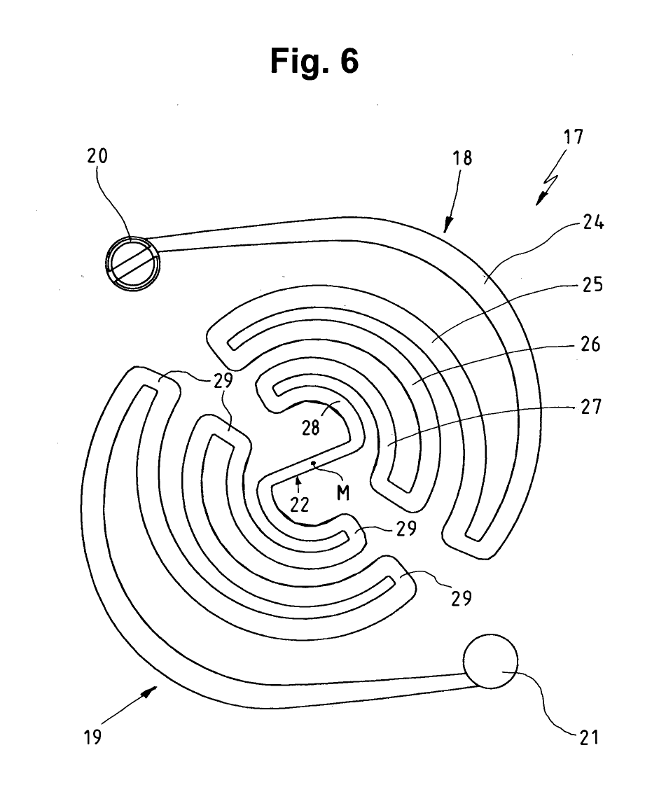

FIG. 6 is a top view of the spring illustrated in FIGS. 2 through 4;

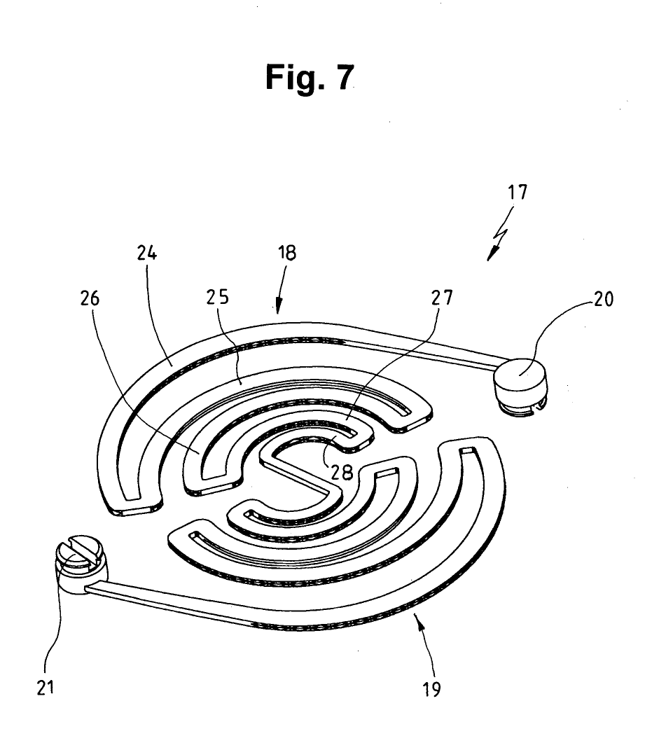

FIG. 7 is a perspective view of the spring of FIG. 6;

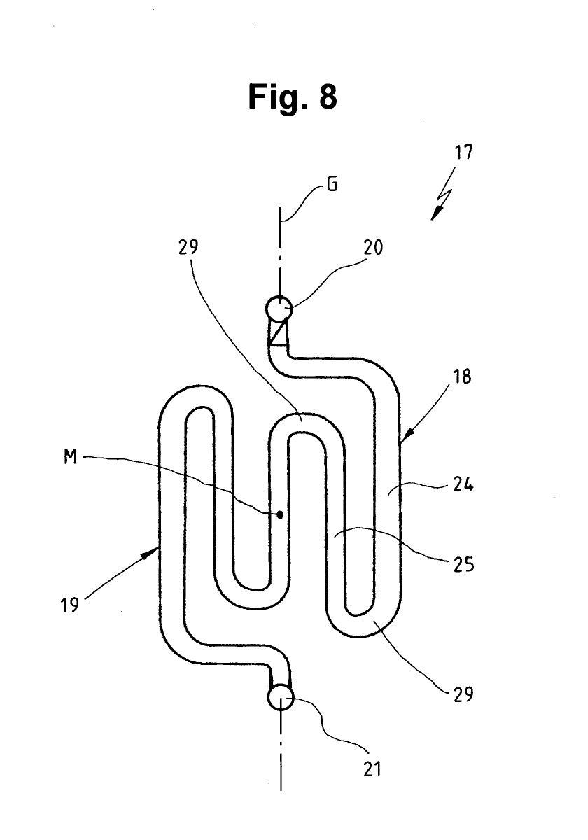

FIG. 8 shows an alternative embodiment of a spring for use in the slide mechanism; and

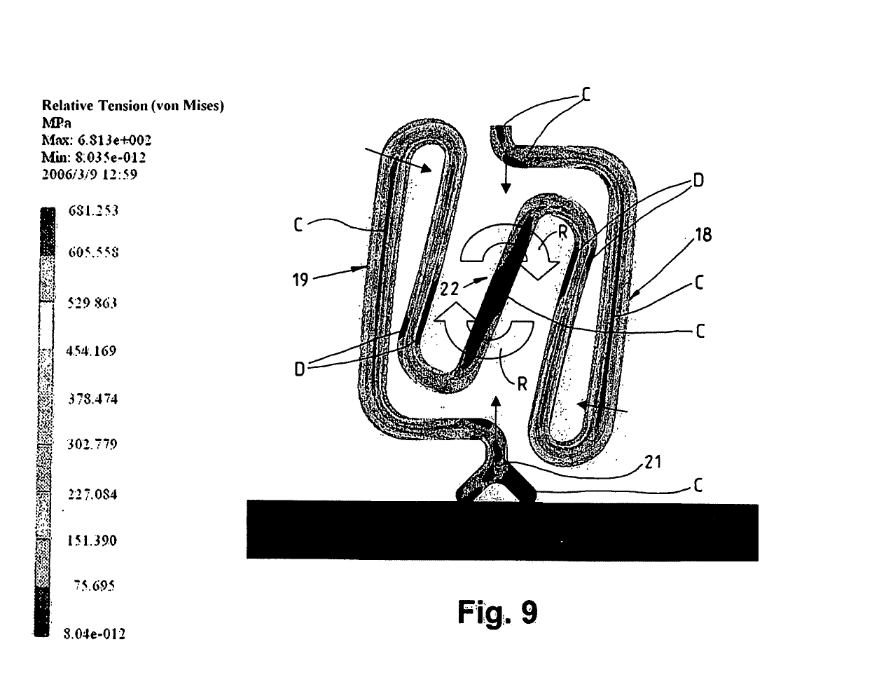

FIG. 9 is an illustration of the spring of FIG. 8 revealing the tensions within the spring.

In the figures, a portable device—such as, for example, a cellular telephone, portable computer (notebook, laptop, or tablet PC) or personal digital assistant (PDA)—is identified collectively by reference number 10.

The device 10 has a slide mechanism identified generally at 11, where a first device part 12—hereinafter also identified as the bottom shell 12—is movable relative to a second device part 13—hereinafter identified as the top shell 13—the two being movable relative to each other.

In FIGS. 2 through 4, the device 10 is shown without 13 so as to provide a view of the slide mechanism 11. The slide mechanism 11 first of all comprises a guide frame 15 and a slide 16 that is movable on the frame 15. The frame 15 and slide 16 define the paths of motion for the top and bottom shells 12 and 13.

In the embodiment, the frame 15 is associated with the top shell 13 or second device part 12, and is designed as an intermediate part. It is also equally possible for the frame 15 and the slide 16 to be an integral part or material-uniform-integral parts of the top shell 13 and bottom shell 12.

The only additional element required by the slide mechanism 11 according to the invention is a spring 17 that functions to semiautomatically open the device 10, that is, to effect a semiautomatic motion of the bottom shell 12 relative to the top shell 13.

The spring 17 has a first spring leg 18 and a second spring leg 19 having respective connection points 20 and 21 and coupled to each other by means of a toggle leg 22. The fundamental design can best be seen in the base form of spring 17 in FIG. 5.

The spring 17 is designed point-symmetrically relative to a center point M, and for this reason the center point M is also identified as a symmetry point M. With reference to end points 23 of the toggle leg 22 where it is connected to the spring legs 18 and 19, the center or symmetry point M is located approximately in the center of the toggle leg 22. At the same time the center point M corresponds to the intersection of a straight line G drawn between the connection points 20 and 21 and crossing the toggle leg 22.

The importance of the toggle leg 22 can be explained most easily with reference FIG. 5. When pressure is applied to the connection point 20 (in arrow direction 31), the force applied to the spring leg 18 results not only in an elastic deformation of the spring leg 18 but is also transmitted to the toggle leg 22. The toggle leg deflects at its right-hand end 23 as shown in FIG. 5 in the direction of arrow 14. At the same time, the left end 23 of toggle leg 22 as shown in FIG. 5 pivots in the same direction (arrow 14). The symmetry point here of the toggle leg migrates in the direction of connection point 21 along a straight line G. As a result, the spring 17 compresses while moving in a straight line and rotating about its center point M. A force in the direction of arrow 32 works analogously.

The point-symmetrical design of the spring 17 relative to the center point M of the toggle leg 22 in combination with the curved spring legs centered on this symmetry point M thus produce a rotation of spring 17 while creating spring tensions centered on the point M, and thereby a self-stabilization, so that connection points 20 and 21 move toward each other in linearly along the straight line G.

With regard to the alternative design of spring 17 illustrated in FIGS. 8 and 9, it should be explained that the above-described principles of action also apply here. The parallel orientation of spring-leg segments 24 and 25 relative to the straight line G and of the toggle leg 22 only change the spring characteristic.

Due to the straight-line motion of the connection points 20 and 21, only one spring 17 is required in the slide mechanism 11 according to the invention.

As is evident in particular in FIGS. 2 through 5, the connection points 20 and 21 connect the spring 17 respective to the bottom shell 12 (connection point 21) and the to top shell 13 (connection point 20), the connection points being preferably designed as fastening eyes that engage top or lower detents formed by transverse-slotted pins to secure the spring 17.

FIGS. 6 and 7 show a spring 17 of more complex design as compared to FIG. 5, this spring being preferably used in the slide mechanism 11 according to the invention (see also FIGS. 2 through 4). The spring 17 in FIG. 6 has spring legs 18 and 19 that are multiply looped in a meander or labyrinth shape. The spring legs 18 and 19 here each have a total of five segments identified at 24 through 28, beginning with first segment 24 through a fifth segment 28. The spring-leg segments 24 through 28 are in each case interconnected one to the next by one meander-type bight 29 each.

Aside from the material selected for the spring—this can be fabricated not only out of suitable metals but also out of plastic—the number of turns formed by the spring-leg segments 24 through 28 and meander-type bights 29 determine the spring resistance and spring travel. Depending on the requirements to be met by the slide mechanism 11, additional spring turns can be used to adapt the spring 17 to the given specifications, e.g. for the space available for the spring 17, force requirements for moving the parts of the device, the requisite spring travel, or the physical limits of the material.

In addition to what was described above, another perspective view of the spring 17 provided in FIG. 7 illustrates another possible approach for fastening the connection points 20 and 21 to the top and bottom shells 13 and 12, or to intermediate parts.

In place of the above-described connection points 20 and 21 that are designed as fastening eyes, in FIG. 7 these are now provided with the detents, already mentioned above, in the form of transverse-slotted pins that engage corresponding detent holes, not shown, in the top and bottom shells 13 and 12, for anchoring the ends of the spring 17.

The perspective view also discloses the essential advantage of the spring 17 as compared to springs of the prior art. The springs used up until now require a certain minimum overall height for the slide mechanism as a function of the number of stacked spring turns. In the spring shown here, the spring turns lie adjacent each other in a single common plane, with the result that only the thickness or height of the material determines the height of the spring 17.

Additionally now shown here, but described in detail by a priority document, is the fact that the spring 17 can have a bearing, in particular at its center point M, by which this element is rotatably or pivotally mounted on a device part such as the top and bottom shells 13, 12. This mounting prevents any relative motion of the spring relative to the respective device part.

FIGS. 2 through 4 show the sliding motion of the device parts 12 and 13 relative to each other, starting from a first end position (FIG. 2) past a toggle point (FIG. 3) up to the second end position (FIG. 4), where the top shell 12 is to be viewed as stationary, while the frame 15 connected to top shell 13 has moved through a distance S.

In the first end position of the slide mechanism 11 or the top shell 13, the spring 17 has a first rest position; it is in a state of maximum relaxation, in other words, is either essentially untensioned or has a constant pretension with respect to predefined factors.

With reference to FIG. 3, the top shell 13, and thus its associated frame 15, has been displaced up to the toggle point of the spring 17, where the spring 17 is compressed by shortening the distance of the connection points 21 and 20 relative to each other, and has thus been tensioned.

The spring 17 is tensioned by alternately compressing the individual turns or spring-leg segments 24 toward the symmetry point M, or, extending these in the opposite direction, away from the symmetry point M.

This is in particular shown clearly in FIG. 3 when the toggle point is reached at which the spring 17 is loaded with maximum spring tension. The two outer or first spring-leg segments 24 of first spring leg 18 and of second spring leg 19 are so highly compressed toward the center point M that in a region 30 they are close to touching the connection points 20 and 21 and the respective second spring-leg segments 25.

At the same time, each second spring leg 25 is extended or deflected in the opposite direction away from the symmetry point M. This is particularly evident when making a comparative examination of FIG. 3 with FIG. 2 or FIG. 4. In the region of meander-type bights 29 connecting the first and second spring-leg segments 24 and 25, the distance between the second spring-leg segment 25 and the adjacent third spring-leg segment 26 is greater than when the spring 17 is in the starting or rest position (see FIG. 2). Only the toggle leg 22 is tension-free despite creating spring tension.

The force actively exerted on the top shell 13 or the frame 15 ends at the toggle point of spring 17 (FIG. 3) when the spring 17 has created its maximum spring tension. Once the toggle point is passed, the spring 17 again releases the spring energy stored when the spring tension was built up and now shifts the top shell 13 automatically to its second end position shown in FIG. 4. Based on a comparison of FIGS. 2 through 4, it is also evident that the spring 17 rotates about its center point M while being tensioned. This motion of the spring alone due to the spring tension is also illustrated in FIG. 9.

The slide mechanism 11 according to the invention is not limited to only a displacement of two device parts using the spring 17 described in detail here; it can also be employed analogously so as to pivot two device parts an arcuate movement, where the link 11 must be designed accordingly.

FIG. 8 shows another alternative embodiment of the spring 17, as has also been disclosed in the priority document. This spring 17 has multiple spring turns formed by spring-leg segments 24 and 25 (identified as spring segments in the priority document) that are interconnected by meander-type bights 29, and is in particular distinguished by the fact that the individual spring-leg segments are not curved, but are instead straight. It is obvious that this type of spring is also usable in the slide mechanism 11. Curved or C-shaped spring-leg segments have the advantage, however, that they occupy significantly less space given the same length. In regard to rotation of the spring 17 (see FIGS. 2 through 4, and 9), the space of rotation is furthermore significantly smaller for curved springs.

FIG. 9 illustrates the tension ratios prevailing in spring 17, presented here in various alternative approaches, in response to the creation of a spring tension. FIG. 9 is also reproduced in the priority document as FIG. 13, and for this reason explicit reference is made to the relevant disclosed content of the priority document.

The dark regions of the spring 17 indicated at C represent regions virtually free of tension, where the tension increases in the increasingly lighter regions. The dark regions identified at D in turn are sites of greatest spring tension. This diagram clearly illustrates that the tension ratios relative to the center point M, not shown here, of the toggle leg 22 are also mirror-symmetrical. The toggle leg 22 is itself largely tension-free and by itself has a negligible spring action. It functions primarily to connect the inner ends of the two spring legs 18 and 19. Also illustrated is the rotational motion of the spring 17 about the center point M of the toggle leg 22 by means of arrows R.

1. A slide mechanism for portable devices, such as cellular telephones, portable computers, or personal digital assistants, comprising a first device part, for example, a bottom shell, and a second device part, for example, a top shell, the bottom shell and top shell being movable relative to each other such that by means of a control mechanism defining a direction of motion they can occupy a first end position and second end position, and comprising at least one spring, whose first connection point is on the bottom shell, and whose second connection point is on the top shell, optionally by means of intermediate parts, the relative spring motion of a device part from one end position to a toggle point being used to create spring tension in the spring that pushes the device part to its other end position wherein the spring has two spring legs each having one of the connection points, the spring legs being coupled to each other by an essentially tension-free force-transmitting member.

2. The slide mechanism according to claim 1 wherein the spring is point-symmetrical relative to its center point.

3. The slide mechanism according to claim 2 wherein the spring performs a rotational motion about its center point while creating and releasing the spring tension.

4. The slide mechanism according claim 2 wherein the spring legs are essentially curved around the force-transmitting member or the center point of the spring.

5. The slide mechanism according to claim 2 wherein the spring legs are of a meander-type design, the individual spring-leg segments being connected with each other by meander-type bights.

6. The slide mechanism according to claim 5 wherein the spring-leg segments are essentially curved around the force-transmitting member and/or the center point of the spring.

7. The slide mechanism according to claim 2 wherein the force-transmitting member has a bearing at the symmetry point at which the spring is rotatably mounted on at least one of the device parts.

8. The slide mechanism according to claim 1 wherein the spring is punched from a foil or a metal sheet.

9. The slide mechanism according to claim 1 wherein the spring is injection molded.

10. The slide mechanism according to claim 2 wherein the center point of the spring is situated approximately in the center on the force-transmitting member.

11. In a portable device having first and second parts shiftable relative to each other in a direction between a pair of end positions, a slide mechanism comprising:
respective first and second anchor points on the first and second parts;
respective first and second spring arms substantially coplanar with each other and each having an outer end connected to a respective one of the anchor points and an inner end; and
a respective force-transmitting member substantially coplanar with the spring arms and connected between the inner ends.

12. The slide mechanism defined in claim 11 wherein the first and second spring arms and member are unitary with each other and are symmetrical to a center point centrally located on the member.

13. The slide mechanism defined in claim 12 wherein the anchor center points are positioned symmetrically and transversely offset from a line parallel to the direction and passing through the center point, whereby on movement between the end positions the spring rotates about the center point.

14. The slide mechanism defined in claim 12 wherein the spring legs are arcuate and centered on the center point.

15. The slide mechanism defined in claim 12 wherein the legs are each formed by a plurality of parallel sections connected together by bights.

16. The slide mechanism defined in claim 15 wherein the sections are arcuate and have centers of curvature substantially at the center point.

17. The slide mechanism defined in claim 12, further comprising
a pivot on one of the parts at the center point connected to the member and pivoting the member at the center point at an axis substantially perpendicular to the plane of the spring.

18. The slide mechanism defined in claim 12 wherein the spring is formed of sheet metal.

19. The slide mechanism defined in claim 12 wherein the spring is formed of plastic.

20. The slide mechanism defined in claim 12 wherein the center point is equidistant between the inner ends.
